(19) United States
(12) Patent Application Publication
(10) Pub. No.: US 2013/0340892 A1
(43) Pub. Date: Dec. 26, 2013

(54) METHOD OF ESTIMATING TIMBER STIFFNESS PROFILES

(71) Applicant: WQI Limited, (US)

(72) Inventors: Jeffrey PARKER, Rotorua (NZ); Marco LAUSBERG, Rotorua (NZ)

(73) Assignee: WQI LIMITED, Rotorua (NZ)

(21) Appl. No.: 13/886,168

(22) Filed: May 2, 2013

(30) Foreign Application Priority Data
May 3, 2012 (NZ) 599764

(51) Int. Cl. G01N 29/04; B27B 1/00

(52) U.S. Cl. CPC G01N 29/045; B27B 1/00
USPC 144/356; 73/584; 73/12.01; 83/72

(57) ABSTRACT

A method and apparatus for maximising value when breaking down a tree stem, log, cant, flitch or slab to sawn timber which includes determining an acoustic velocity value and determining density profile information across the width of the stem, log, cant or slab. The density profile information determined includes a position of minimum density in the stem, log, cant or slab. This enables the prediction of a stiffness profile across the stem, log, cant or slab from the acoustic velocity and the density profile information across the stem, log, cant or slab. The stiffness profile and the position of minimum density in the stem, log, cant or slab can be used to generate a sawing pattern for cutting the stem, log, cant or slab. The sawing pattern is offset by the position of the minimum density for a more useful yield of sawn timber.

### FIELD OF THE INVENTION

The present invention relates to an improved method and apparatus for maximising value when breaking down a tree stem, log, cant, flitch or slab to sawn timber.

### BACKGROUND TO THE INVENTION

U.S. Pat. No. 6,889,551 discloses a method of lumber break down to maximise the value of the lumber recovered from a log or similar by a system which includes determining an acoustic velocity in the log to predict an average modulus of elasticity, determining density profile information, and utilising the stiffness profile in cutting the log, typically by generating a sawing pattern for the log.

It is an object of the present invention to provide an improved method and apparatus for breaking down a tree stem, log, cant, flitch or slab to sawn timber, or to at least provide the public with a useful choice.

### SUMMARY OF THE INVENTION

In one aspect in broad terms the invention comprises a method of breaking down a stem, log, cant or slab which includes:
determining an acoustic velocity value for the stem, log, cant or slab,
determining density profile information using x-ray radiation across the width of the stem, log, cant or slab, including locating a position of minimum density in a stem, log, cant or slab,
predicting a stiffness profile across the stem, log, cant or slab from the acoustic velocity and the density profile information across the stem, log, cant or slab, and utilising the stiffness profile in cutting the stem, log, cant or slab including locating a sawing pattern for the stem, log, cant or slab by locating a centre of the sawing pattern in a predetermined position relative to the determined position of minimum density of the stem, log, cant or slab.
The method may include estimating elasticity or stiffness profile across the length of timber by calculating an initial profile of elasticity or stiffness across the timber using an elasticity model of the timber, and determining a revised elasticity or stiffness profile using the measured velocity, density information and initial elasticity profile and/or validating the elasticity or stiffness profile by calculating a velocity of a compression wave in the timber using the density information and elasticity or stiffness profile and comparing the calculated velocity with the measured velocity.

Preferably determining density profile information using x-ray radiation includes moving the stem, log, cant or slab through at least one beam of x-ray radiation or moving at least one source of x-ray radiation relative to the stem, log, cant or slab.

Preferably determining density profile information includes measuring x-ray radiation energy after propagating through a stem, log, cant or slab.

Preferably the method further comprises generating a sawing pattern from the determination of the position of minimum density.

In a second aspect the invention may broadly be said to consist of a method of breaking down a stem, log, cant or slab comprising the steps of:
determining an acoustic velocity value for the stem, log, cant or slab,
determining density profile information across the width of the stem, log, cant or slab, including locating a position of minimum density in a stem, log, cant or slab,
predicting a stiffness profile across the stem, log, cant or slab from the acoustic velocity and the density profile information across the stem, log, cant or slab, and
utilising the stiffness profile across the stem, log, cant or slab to generate a sawing pattern for cutting the stem, log, cant or slab.

In one embodiment the method further comprises cutting the stem, log, cant or slab by locating a centre of the sawing pattern in a predetermined position relative to the determined position of minimum density of the stem, log, cant or slab.

In one embodiment the step of predicting the stiffness profile across the stem, log, cant or slab comprises calculating an initial profile of stiffness across the stem, log, cant or slab from an elasticity model of the stem, log, cant or slab, and determining a stiffness profile using the acoustic velocity value for the stem, log, cant or slab, the density profile information and the initial stiffness profile.

Preferably the method further comprises validating the stiffness profile by calculating a velocity of a compression wave in the stem, log, cant or slab from a velocity profile derived from the density profile information and the stiffness profile, and comparing the calculated velocity with the acoustic velocity value.

Preferably the method further comprising adjusting the stiffness profile according to the comparison and validating the adjusted stiffness profile in accordance with the steps of claim 3.

In one embodiment the step of determining density profile information includes subjecting the stem, log, cant or slab to x-ray radiation.

Preferably determining density profile information further includes measuring the x-ray radiation energy level after propagating through the stem, log, cant or slab.

The x-ray radiation may comprise a collimated beam, a diverging beam, a converging beam, or any combination thereof.

The x-ray radiation may be provided by one or multiple radiation source(s).

Preferably the method further comprising calibrating the x-ray radiation to an energy level prior to subjecting the stem, log, cant or slab to the x-ray radiation. Preferably calibrating the x-ray radiation comprises passing a control stem, log, cant or slab through the x-ray radiation and adjusting the x-ray radiation energy level to an appropriate energy level for the control.

Preferably subjecting the stem, log, cant or slab to x-ray radiation comprises moving the stem, log, cant or slab through at least one beam of x-ray radiation. Alternatively subjecting the stem, log, cant or slab the step to x-ray radiation includes moving at least one source of x-ray radiation relative to the stem, log, cant or slab.

In one embodiment the step of determining an acoustic velocity value of the stem, log, cant or slab comprises applying a force to the stem, log, cant or slab and measuring a frequency of vibration resulting from the applied force.

Preferably the method further comprises forming one or more laser marker lines on the stem, log, cant, or slab in accordance with the sawing pattern and cutting the stem, log, cant or slab with a cutting machine in accordance with the marker lines.

In a third aspect the invention may broadly be said to consist of a method of determining a stiffness profile of a stem, log, cant or slab comprising the steps of:
determining an acoustic velocity value for the stem, log, cant or slab,
determining density profile information across the width of the stem, log, cant or slab, including locating a position of minimum density in a stem, log, cant or slab, and
predicting the stiffness profile across the stem, log, cant or slab from the acoustic velocity and the density profile information across the stem, log, cant or slab.

In a fourth aspect the invention may broadly be said to consist of a system for breaking down a stem, log, cant or slab comprising:
a measuring system configured to:
   determine an acoustic velocity value for the stem, log, cant or slab, and
   determine density profile information across the width of the stem, log, cant or slab, including locate a position of minimum density in a stem, log, cant or slab, and at least one processor configured to predict a stiffness profile across the stem, log, cant or slab from the acoustic velocity and the density profile information across the stem, log, cant or slab, for generating a sawing pattern for cutting the stem, log, cant or slab, wherein the sawing pattern is dependent on the position of minimum density of the stem, log, cant or slab.

Preferably the system further comprises an output monitor for displaying the predicted stiffness profile across the stem, log, cant or slab.

Preferably the measurement system comprises at least one x-ray radiation source and at least one x-ray radiation detector configured to locate on either side of the stem, log, cant or slab in a density measurement position of the stem, log, cant or slab in use, the at least one source configured to apply x-ray radiation energy through the stem, log, cant or slab and the at least one detector configured to receive and measure an energy level of x-ray radiation propagating through the stem, log, cant or slab, and the measurement system further comprising at least one processor configured to determine the density profile information from one or more energy levels measured by the at least one detector across the stem, log, cant or slab.

Preferably the at least one source is located above the stem, log, cant, or slab in the density measurement position, and the at least one detector is located underneath the stem, log, cant or slab in the density measurement position.

Preferably the measurement system comprises a compressed air driven hammer located adjacent the stem, log, cant or slab in an acoustic velocity measurement position of the stem, log, cant or slab in use and configured to strike the stem, log, cant or slab to stimulate vibration in said stem, log, cant or slab, and an accelerometer configured to locate against an end of the stem, log, cant or slab in the acoustic velocity measurement position in use, and output data relating to a frequency of the vibration, the measurement system further comprising at least one processor configured to determine the acoustic velocity value from the frequency data of the accelerometer.

Preferably the system further comprises a cutting system including:
a laser source configured to generate at least one laser marker cutting line on the stem, log, cant or slab corresponding to the sawing pattern, and
a sawing machine configured to cut the stem, log, cant or slab in accordance with the at least one laser marker cutting line.

Preferably the system further comprises a transport system configured to convey the stem, log, cant or slab in use first to a measurement stage associated with the measurement system and then to a cutting stage associated with the cutting system.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

As used herein the term “and/or” means “and” or “or”, or both.

### BRIEF DESCRIPTION OF THE FIGURES

The invention is further described with reference to the accompanying figures in which:

FIG. 1 is a flow diagram which comprises schematic overview of the information and processing required for MoE estimation according to the invention.

FIG. 2 is a flow diagram showing a preferred form methodology for estimating an MoE profile for a log or cant.

FIGS. 3A-3C show density, MoE and velocity profiles respectively as a function of timber radius.

FIG. 4A-4D show initial and revised MoE profiles as a function of timber radius.

FIGS. 5A-5D show in further detail a preferred form method for estimating an MoE profile.

FIG. 6 shows a graph of measured density profile information.

FIG. 7A-7C show structural sawing patterns for a cant with a position of minimum density located at the geometrical centre.

FIG. 8A-8B show a cant having a position of minimum density located offset from the geometrical centre and associated sawing patterns.

FIG. 9 schematically illustrates a preferred form of apparatus of the invention in plan view.

FIG. 10 schematically illustrates a preferred form of apparatus of the invention in perspective view.

FIG. 11 shows a graph of the mean cant MoE for the group having high acoustic velocity.

### DESCRIPTION OF PREFERRED EMBODIMENTS

In the method of the invention an acoustic or sonic velocity measure obtained for a log or cant is combined with a radial density profile for the log or cant which will typically be green, i.e. undried and typically freshly cut and thus high moisture content, to derive a radial profile of its MoE. This MoE stiffness profile can be used to estimate the dry MoE of timber sawn from the sample and to determine how to saw the log or cant to maximise recovery of high value timber for structural applications. The position of minimum density in the log or cant is determined and used to locate the centre of a sawing pattern at the minimum density position of the log or cant and/or in the calculation of a sawing pattern.

As disclosed in U.S. Pat. No. 6,889,551 when a wood stem or log or cant receives an acoustic impulse, by striking the sample, with a hammer for example, the speed of longitudinal waves can be calculated from the formula

V=2f₀L 1

where L is the sample length, f₀ the fundamental or lowest longitudinal mode, and V the desired speed of longitudinal compression (i.e. sound) waves. V is in turn related to the modulus of elasticity E, or MoE, by the expression

V²=E/ρ 2

where ρ is the material density of the wood. Thus for velocity and in particular from f₀, it is possible to determine an MoE value or value indicative of MoE for the sample. Any suitable system for measuring acoustic velocity may be used.

In equation 2 the relevant density is simply the mass to volume ratio, including the mass of water. It is known that the acoustic-measured MoE remains constant as timber dries from green until the Fibre Saturation Point is reached; in further drying to equilibrium moisture content (about 12% in New Zealand) the sonic modulus increases by perhaps 20%.

The preferred procedure is intended for use with green or undried wood, first because sawing decisions clearly relate to green timber, and second because the water content at this stage largely determines the density. It does this overwhelmingly in the sapwood, and partially in the drier heartwood. A dry MoE can be estimated from a wet value by simply increasing the values by about 20%.

In some forms of the invention the radial velocity profile implied by the MoE and density is integrated across the sample, and the MoE profile is first shifted up or down, by a maximum of 10% for example, to seek agreement with the measured log or cant acoustic velocity. If agreement is not reached within this range, the outer MoE is then clamped, and the core MoE value raised or lowered to generate agreement. (The outer MoE has been found to be more tightly defined by log or cant acoustic velocity than the core MoE.)

Regardless of the basic dry density, the density of the outer sapwood in green p. radiata is typically around to 1050 kg/m³, while that of the drier inner wood is more variable but typically around 550 kg/m³. The result is that the acoustic velocity in this species is not a strong function of radius. The velocity in the weak inner wood is raised by its lightness while the velocity in the stronger outer wood is lowered because of its higher density. The velocity at any location is found to be not far from the average velocity for the whole log or cant. The location of particular interest is the zone near the bark where it is known that all p. radiata trees have a density of about 1050 kg/m³. Combining this density with the acoustic velocity for the whole log or cant gives an estimate of the MoE of the wood near the bark. The MoE information can be refined if more information on the wet density is available. The approach is to begin with a first radial profile based on equations formulated from data which indicate the likely core and bark values of MoE and a radial profile of wet density measured for each log or cant). The density and MoE profiles define a radial profile of acoustic velocity whose appropriately weighted average should equal that measured sonically for the whole log or cant. If the computed velocity does not agree with the measured velocity corrections to the MoE must be made as will be described in detail below.

Variations are possible. For example, constraints can be put on the radial MoE profile to prevent non-physical results occurring, and other modifications to a parabolic profile can be incorporated. These will depend on knowledge of the particular species likely to be encountered. It is known from the literature that corewood MoE correlates with dry (and wet) density, so when core MoE is changed, a corresponding change in the density may be made.

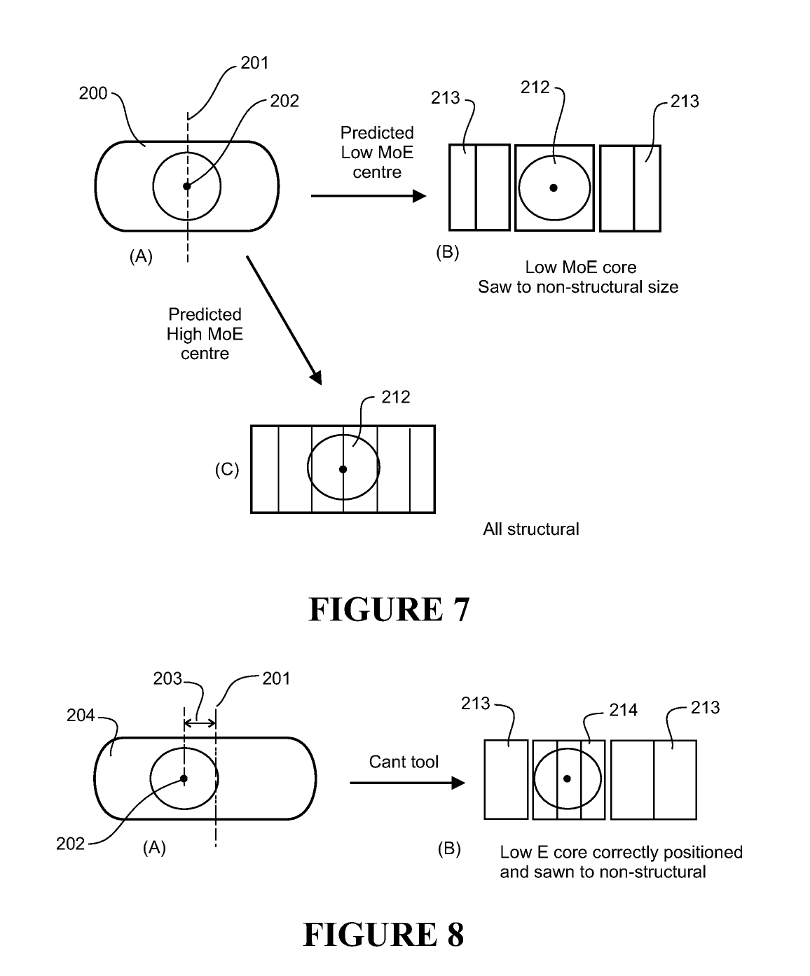

An accurate density profile is desirable. One reason is because the cant may have a position of minimum density, or heartwood, or pith, located in the geometrical centre relative to its lateral width. FIG. 7A shows a cant 200 having the point of minimum density 202 located in the geometrical centre 201. The cant 200 can be sawn using a non-structural pattern such as shown in FIG. 7B where the sawing pattern is aligned to extract structural timber 213 and exclude the low density core 212. In such circumstances where the core 212 is of a high density, the entire cant can be cut into structural timber such as shown in FIG. 7C. However, in some circumstances the position of minimum density 202 is not located at the geometrical centre 201 as traditionally assumed. It is therefore advantageous to locate the true position of minimum density to facilitate an improved sawing pattern that extracts most value from the sawn timber.

FIG. 8A shows a cant 204 having the position of minimum density 202 laterally offset by a distance 203 from the geometrical centre 201. Determination of the offset distance 203 allows the sawing pattern to be adjusted to extract the maximum value of timber from the cant. It should be noted that the vertical height of the true position of minimum density 202 is of little importance since the usual thickness of the timber when sawn is merely 100 mm. The relative stiffness of the sawn timber can be further evaluated by later procedures such as the bending test. FIG. 8B shows a sawing pattern for the cant 204 where the sawing pattern is aligned to avoid structural timber 213 being cut from the low density core 212. The improved sawing pattern allows greater value to be extracted from the timber sawn from the cant by ensuring non structural timber is sawn from the low density sections of the cant and structural timber is sawn from the high density sections of the cant.

It should be appreciated that when the specific sawing pattern is evaluated in response to a determination of the true position of minimum density, the sawing pattern will include a method for evaluating one or more of the measured width, height, acoustic velocity and determined density profile information, and outputting a pattern indicative of cut placement or desired structural timber sizes.

Preferably the length of timber is a stem, log, or cant and characteristics that the density model is based upon include the density of an outer portion of the stem, log, or cant, the density of an inner portion of the stem, log, or cant, and a transition between the outer and inner densities at a radial position determined by the equation:

R_{core}=aD−b

where R_{core} is the radius of the transition, D is the diameter of the timber, and a, b are characteristic parameters previously determined for the wood species.

Preferably the method further comprises calculating a velocity of the compression wave in the timber calculating a velocity profile of a compression wave in the timber using

$${V ( R )}^{2} = \frac{MoE ( R )}{Density ( R )}$$

where V(R) is the velocity as a function of timber radius, MoE(R) is the modulus of elasticity of the timber as a function of radius and Density(R) is the density of the timber as a function of radius, and averaging V(R) over the timber radius.

Preferably the length of timber is a cant and V(R) is averaged using:

$${V}_{av} = \frac{1}{{R}_{max}} {\int }_{0}^{Rmax} V ( R ) d R$$

Preferably the length of timber is a log and V(R) is integrated using:

$${V}_{av} = \frac{2}{{R}_{max}^{2}} {\int }_{0}^{Rmax} RV ( R ) d R$$

Preferably the method further comprises utilising the stiffness or elasticity profile in determining the placement of sawing points or a sawing pattern for a stem, log, or cant.

Preferably the method further comprises utilising the elasticity or stiffness profile in sawing side slabs from a stem or log to form a cant or slab.

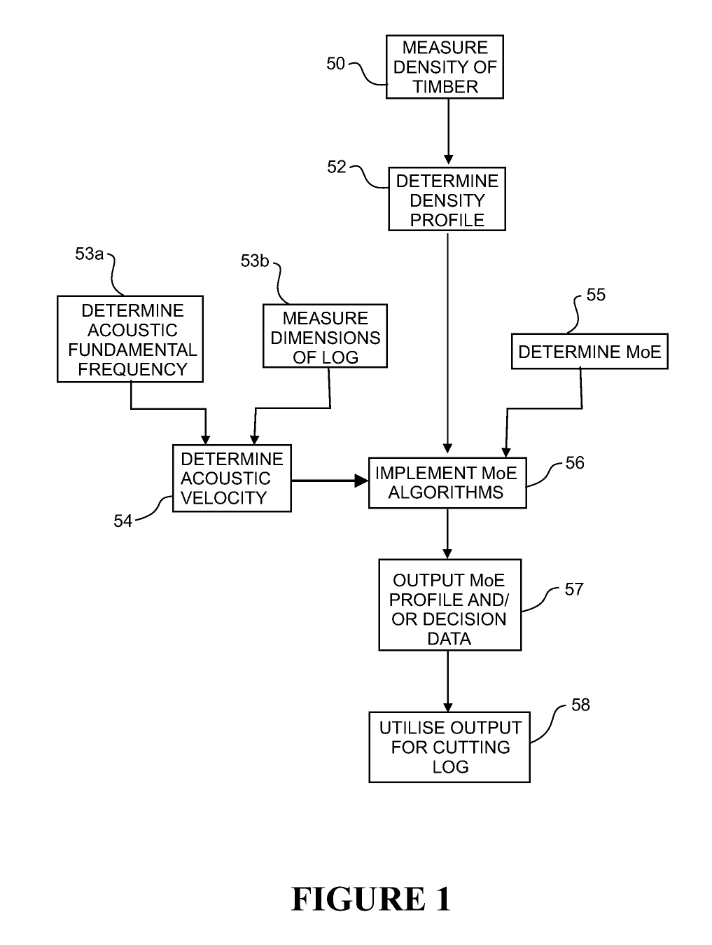

FIG. 1 is a schematic overview of the information and processing used in a method of determining an elasticity profile. A density profile of the timber is determined as indicated at 52 by measuring the density profile for the stem, log or cant as indicated at 50 using a suitable technique. Alternatively, and preferably, the wet density profile is used directly from the measurement by microwave or x-ray assessment. Then the velocity of an acoustic or other compression wave in the timber is also determined as indicated at 54. Preferably this is calculated from the plane compression wave in the timber as indicated at 53b and the length of the timber 53b.

Data relating to MoE characteristics of the stem, log or cant being analysed is also obtained and used to formulate characteristic MoE equations for the species as indicated at 55. Such data will typically have been measured from analysis of the stem, log or cant to be sawn. The density, acoustic velocity, dimensional and measured MoE information is then used to calculate an MoE profile across the stem, log or cant as indicated at 56. The calculated MoE profile for the stem, log or cant may be output for use as indicated at 57 or alternatively used to provide information to a log breakdown sawing system or a manual saw operator, or a cut placement or a sawing pattern for the stem, log or cant to maximise the value or value as structural timber obtained. This general method can be carried out individually for each stem, log or cant that is processed.

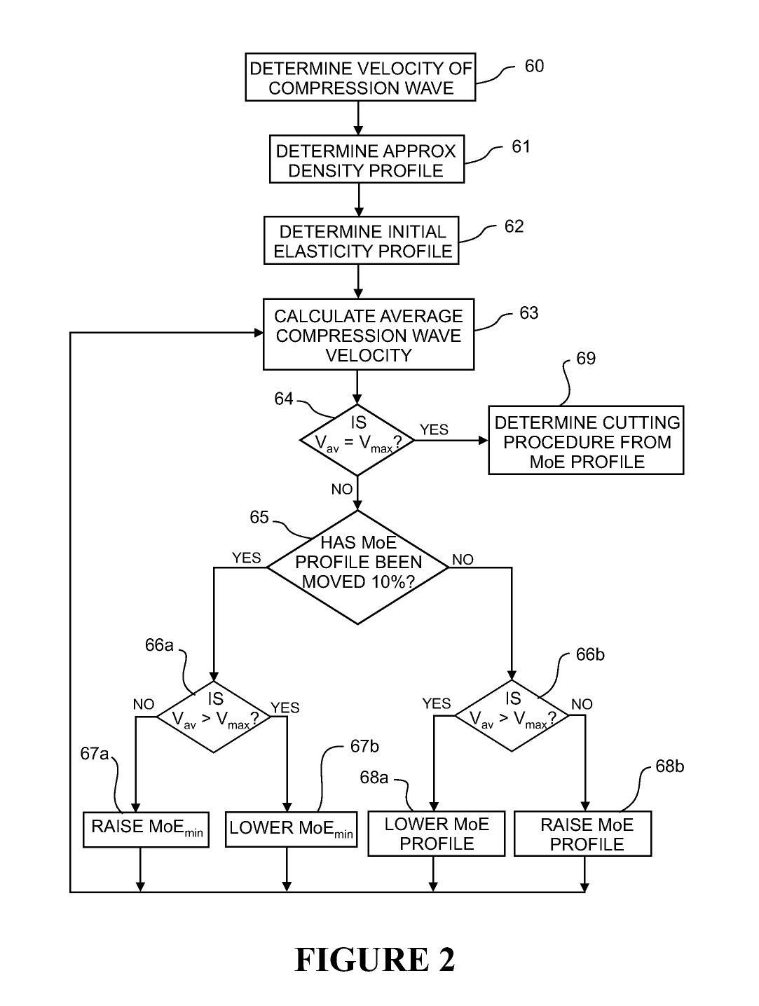

FIG. 2 shows a preferred method for carrying out the method shown in FIG. 1. It will be appreciated that the flow chart depicted is exemplary and many of the steps do not necessarily have to be carried out in the order shown. The actual order of implementation may be differ depending on the configuration of the apparatus carrying out the method and the requirements of the operator.

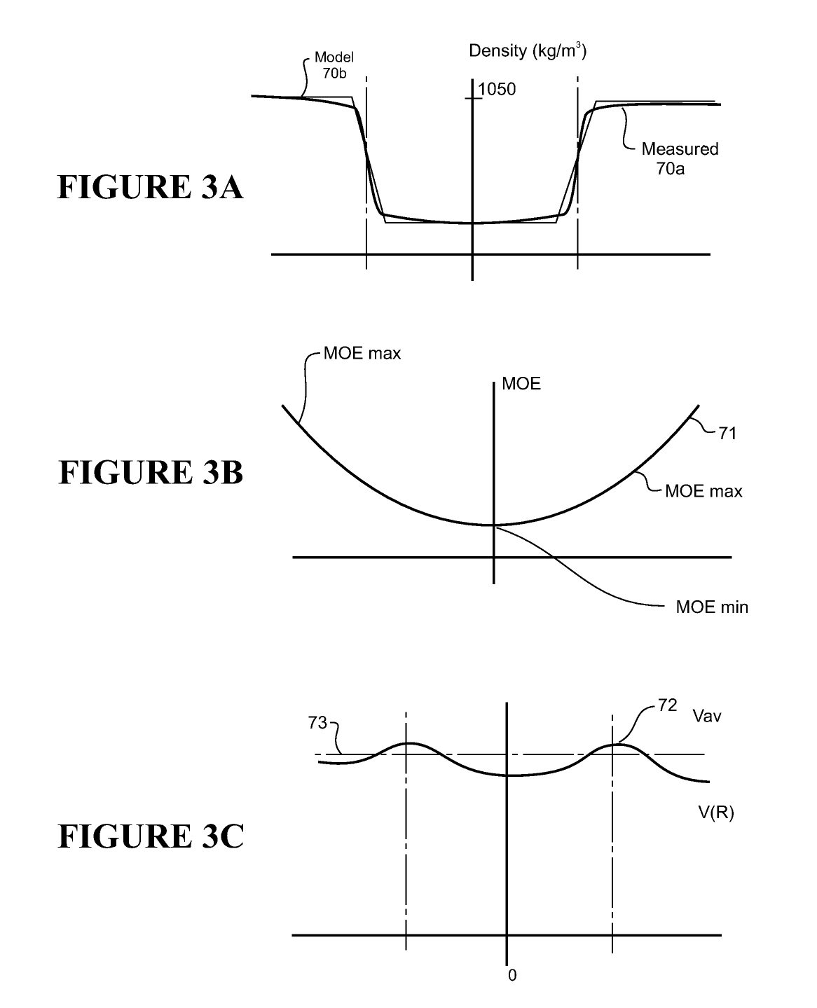

The velocity (Vₘₑₐₛ) of the plane compression wave in the stem, log or cant is determined as indicated at 60 using a suitable acoustic technique. A density profile across the radius of the stem, log or cant is then measured as indicated at 61. Examples of both a measured density profile 70a and estimated density profile 70b are shown in FIG. 3A. Typically in p. radiata the wet density across the diameter has a low zone corresponding to the relatively dry heart or transition wood and a high zone corresponding to the water saturated sapwood. The boundary between the regions can be quite abrupt.

An initial MoE/elasticity profile is then determined as indicated at 62 using the measured velocity, Vₘₑₐₛ and an appropriate model which is formulated through experimentation. For p. radiata this involves determining MoEₘₐₓ corresponding to the sapwood elasticity and MoEₘᵢₙ corresponding to the heartwood elasticity. An approximately parabolic curve which fits the data is then formulated which enables an initial estimate of the elasticity at all points across the diameter of the timber to be calculated. The resulting initial elasticity profile 71 (see FIG. 3B) is then utilised along with the measured density profile to determine a calculated velocity profile 72 across the timber (see FIG. 3C). This velocity profile indicates the predicted velocity of a plane compression wave travelling lengthwise through the timber, as a function of radius. This calculated velocity profile is then averaged as indicated at 63 in FIG. 2 to produce a value Vₐᵥ. This value Vₐᵥ is also indicated in FIG. 3C by the dash-dotted line 73.

At this point an iterative process is undertaken to refine the initial estimate of the MoE/elasticity profile to determine an MoE/elasticity profile which reflects more accurately the actual elasticity across the timber. In general terms this process involves adjusting the initial elasticity profile until, using the estimated or measured density profile, the average of the calculated velocity profile Vₐᵥ more closely approximates the measured velocity of the plane compression wave in the stem, log or cant to within the desired accuracy. More particularly, Vₐᵥ and Vₘₑₐₛ are compared as indicated at 64 to see if these are equal or if they differ. If Vₐᵥ≠Vₘₑₐₛ then some adjustment of the initial MoE is performed. During adjustment of the MoE profile, MoEₘₐₓ is preferably not moved by more than 10% from its measured value.

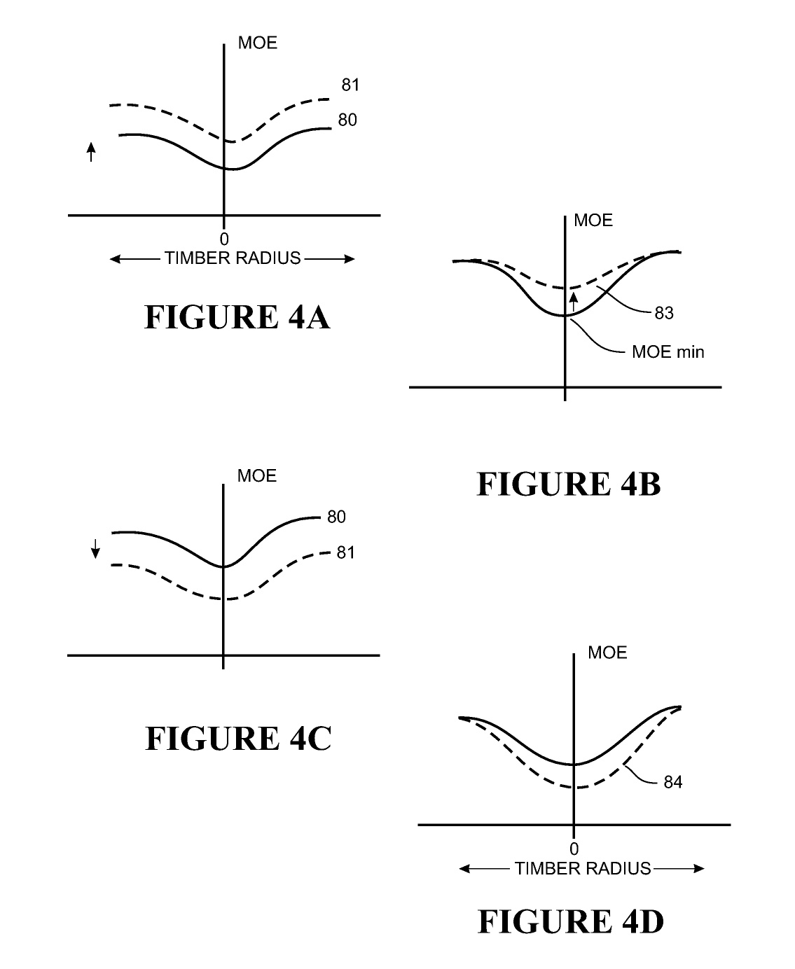

In the form shown it is determined as indicated at 65 if the MoE profile has already been adjusted such that MoEₘₐₓ has been moved more than say 10%. If it has not, and this will be the case in the first iteration, then the entire MoE profile is moved upwards or downwards by a small amount. To do so it is then determined as indicated at 66b whether Vₐᵥ>Vₘₑₐₛ. If it is not then it is assumed that the calculated initial MoE profile is too “low” and the MoE profile is shifted upwards as indicated at 68b. FIG. 4A shows an example of an initial MoE profile 80 and a revised MoE profile 81 which has been shifted upwards. If Vₐᵥ<Vₘₑₐₛ then it is assumed that the calculated MoE profile is too “high” and must be shifted downwards as indicated at 68a to produce a revised MoE profile as shown in FIG. 4C. After adjustment of the MoE profile either up or down, then Vₐᵥ is recalculated as before using the revised MoE profile and the comparison between Vₐᵥ and Vₘₑₐₛ is carried out again. If however the comparison as indicated at 65 reveals that the MoE profile 80 has already been shifted more than 10% from the initial MoEₘₐₓ value during previous iterations, then no more movement of this value is undertaken as it is assumed the actual value should be within 10% of the initially calculated value. Therefore rather than shifting the entire MoE profile up or down, the MoEₘᵢₙ value is adjusted up or down.

To do so it is determined as indicated at 66a whether Vₐᵥ>Vₘₑₐₛ. If it is not then it is assumed that the initial MoE profile is too “low”. In this case the MoEₘᵢₙ value is increased 67a by a small amount to produce a revised MoE profile 83 with a “flatter” shape as shown in FIG. 4B, leaving the MoEₘₐₓ value unchanged. Otherwise if Vₐᵥ>Vₘₑₐₛ then it is assumed that the calculated initial MoE profile is too “high”. The MoEₘᵢₙ value is decreased 67b to produce a “steeper” curve 84 as shown in FIG. 4D. The revised curve 83 or 84 is then used to recalculate the average velocity as before. The comparison steps 64-66b along with the MoE profile adjustment steps 67a-68b are reiterated as appropriate until Vₐᵥ=Vₘₑₐₛ, at which point it is assumed that the revised MoE profile is accurate enough to be used to provide determine how the timber should be cut as indicated at 69.

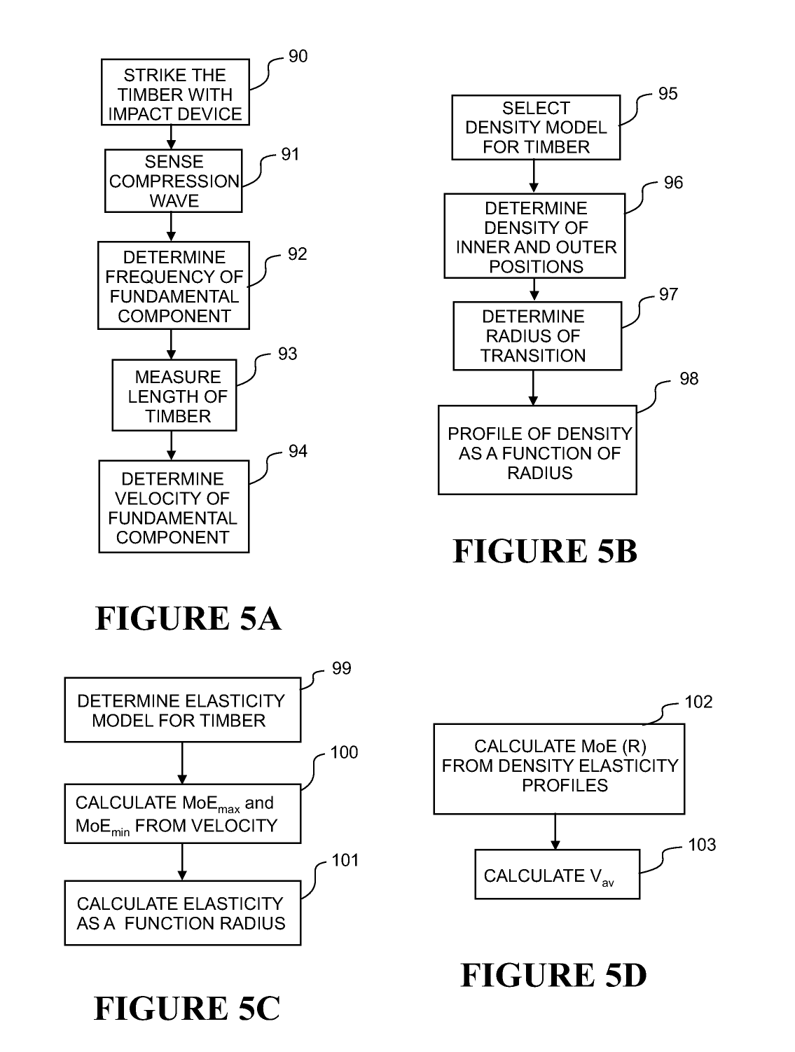

Steps 60-63 shown in FIG. 2 are now be described in more detail with reference to FIGS. 5A-5D. FIG. 5A shows a preferred method of determining the velocity of a plane compression wave in the stem, log or cant which is more particularly described New Zealand patent specification 337015/337186 and New Zealand patent specification 333434 which are incorporated herein by reference.

The length of timber is struck at one end as indicated at 90 with an impact device such as a hammer which induces a range of standing compression waves along the length of the timber. The impact device may be activated automatically using a machine or alternatively may involve manually striking the end of the timber with the hammer. A transducer is then used to detect the compression waves within the stem, log or cant as indicated at 91. The transducer can be any suitable device, such as a piezo-electric accelerometer or the like which is mounted on or near one end of the timber being examined. The output of the transducer is analysed by a processor to determine the frequency of the fundamental component f₀ as indicated at 92 using a suitable signal processing technique. The length of the stem, log or cant is measured as indicated at 93 and this value along with the fundamental frequency is utilised to determine the velocity of the plane wave by way of equation 1 as indicated at 94. This velocity Vₘₑₐₛ, gives a good indication of the velocity of the plane compression wave in the sapwood as discussed previously. This is only one way of finding the compression wave velocity and other suitable techniques known to those skilled in this area of technology could be utilised.

FIG. 5B shows a preferred method of determining an estimated wet density profile 61 across the timber using a predetermined model. Firstly, the appropriate model is selected for the wood type as indicated at 95. The model, for example profile 70a as shown in FIG. 3a for p. radiata, assumes a known outer sapwood density and inner heartwood density and a linear transition between the two. The density of the outer sapwood for p. radiata. is known to be close to about 1050 kg/m³ while the drier inner heartwood is more variable but typically about 550 kg/m³. Through experimentation based on the densities of wet sticks sawn from cants for p. radiata in the 50 log trial the radius in millimetres at which the wood begins to change from the drier core to the wet outer was estimated. In particular from numerical illustrations which were taken from the trial it was determined:

R_{core}=0.5405D−116 3

where R_{core} is the transition radius and D is the stem or log diameter. The radius of the transition point is calculated as indicated 97 using equation 3 to produce the density profile 70b as indicated at 98. The transition point 73 is indicated on the density profile 70b in FIG. 3A.

Alternatively, and preferably, the wet density profile is used directly from the measurement by microwave or x-ray assessment and the MoE profile directly processed from received ray intensity information.

FIG. 5C shows the process for calculating an initial MoE profile 62 (in FIG. 2) which can be used a basis for producing refined MoE profiles. The measured acoustic velocity and density profile obtained previously are used to evaluate the initial MoE profile. Firstly a suitable elasticity model is selected as indicated at 99. In selecting a model it is assumed that the density information is measured although it will be appreciated that the information could also be usefully derived from a density model based on knowledge of the wood type. For simplicity it is further assumed that the stem, log or cant is not tapered and is symmetric, although the models could be easily adapted for different geometries. In this case a model is selected in which the MoEₘₐₓ and MoEₘᵢₙ are calculated as predicted at 100 corresponding to the sapwood and heartwood elasticities respectively. A parabolic relationship between these two values across the timber is assumed and an appropriate equation formulated from experimental data to represent this relationship.

The initial MoE can be defined by:

MoE(R)=MoEₘᵢₙ+(MoEₘₐₓ−MoEₘᵢₙ)(R/Rₘₐₓ)² 8

where R is the radius and Rₘₐₓ is the radius of the stem or log. Once equations have been determined for the model, MoEₘₐₓ and MoEₘᵢₙ are calculated as indicated at 100 using equations 5 and 6 and these values are utilised to calculate the initial MoE(R) indicated at 101 using equation 8. It will be appreciated that a maximum value of MoE(R) may be specified, for example 13 GPa as noted before, to avoid unrealistic values being calculated.

Once the initial MoE has been determined an average velocity is calculated 63 as shown in FIG. 5D. At a given radius R the calculated acoustic velocity is determined 102 by:

$${V ( R )}^{2} = \frac{MoE ( R )}{Density ( R )} \qquad 9$$

The wet density at each radial point is determined through either a model or measurement as described earlier and the MoE at each radial point is determined from the initial MoE calculated using equation 8. The average, Vₐᵥ of the velocity profile V(R) over the entire radius of the timber is then determined 103. For a cant this is preferably done by integrating the V(R) from the centre of a cant to the maximum radius Rₘₐₓ as follows:

$${V}_{av} = \frac{1}{{R}_{max}} {\int }_{0}^{Rmax} V ( R ) d R \qquad 10$$

For a stem or log the increasing area of wood at a given speed as the radius increases means that the average velocity is found by:

$${V}_{av} = \frac{2}{{R}_{max}^{2}} {\int }_{0}^{Rmax} RV ( R ) d R \qquad 11$$

The integration equations assumes a symmetrical stem or log, however this could easily be adapted for non-symmetrical geometries. The average velocity Vₐᵥ, is then used in combination with the measured velocity Vₘₑₐₛ, to refine the MoE profile as described previously with reference to FIG. 2.

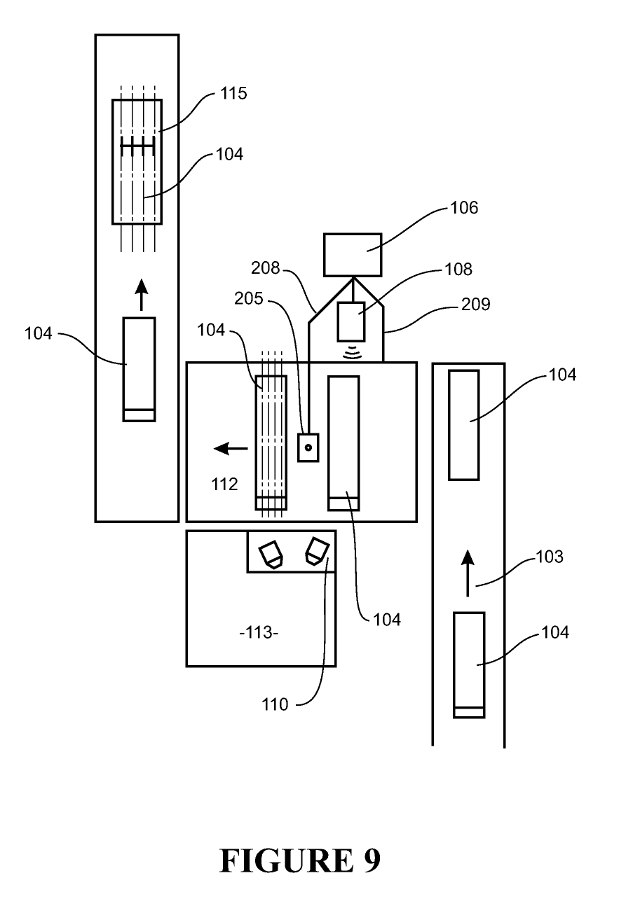

FIG. 9 shows one possible industrial implementation of the method in a saw mill. Logs or cants are processed in a headrig and arrive as cants or logs 104 on a conveyor belt 103. A cant 104 arriving at an entry point for transfer to an adjustable gangsaw 115 are first unloaded onto a transport system 112 which moves each cant 104 individually in turn into a position in front of an operator station 113. En route to the operator station 113 the cant is inspected by an optical measuring system 107 which measures cant length and width, the latter preferably at several places to give knowledge of cant taper. Preferably a non-contact measuring apparatus 108, using microwaves or x-rays, measures the wet density and derives a density profile while the cant passes a read head of the measuring apparatus 108. The cant is then conveyed to a position abreast the acoustic measuring apparatus 109 where the velocity of the plane compression wave in the cant via output monitors 110 is measured. Preferably this comprises an accelerometer pressed against the cant 104 end face which detects reverberations within the cant after it is struck by a hammer. The acoustic assembly 109 includes a compressed air driven hammer and an accelerometer on an arm which can extend from the apparatus 109 to contact the cant end face. A typical saw mill environment contains impulsive noise which can interfere with the acoustic signal sought and it is desirable to have a means of raising the cant on vibration isolating lifters above the transport system 112 while the acoustic measurement is made. The measured information, including the acoustic velocity and the density profile, is then processed by a computer 106 to provide an operator with MoE information, such as the predicted stiffness profile on each successive cant via a monitor 110. The operator positions the subsequent saw cuts for each cant in accordance with MoE information by manipulating laser marker lines 114. The transport system 112 conveys the measured cant 104 to the cutting stage where a sawing machine cuts the cant 104 in accordance with the sawing pattering/laser marker lines 114 determined/manipulated by the operator. In an alternative embodiment, the processor automatically determines and manipulates saw cut locations from the MoE information.

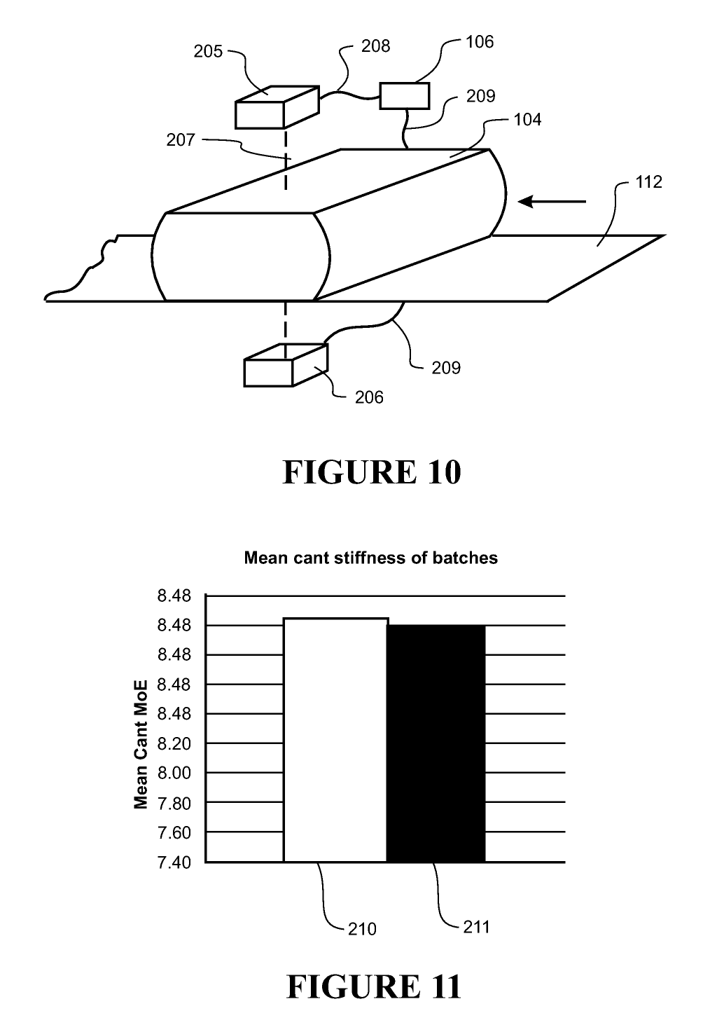

FIGS. 9 and 10 schematically illustrate the preferred embodiment of apparatus of the invention for measuring the true MoE profiles for logs or cants. The true MoE profile reflects the true position of minimum density and whether the position of minimum density is offset from the geometrical centre. It will be appreciated that these figures are illustrative only and not all the apparatus described is necessarily required to implement the method.

A source of x-ray radiation 205 is located above the transport system 112 that supports the cants 104 for delivery to the gangsaw 115. Preferably the x-ray source 205 provides a collimated beam of x-ray radiation. However, other x-ray sources having divergent or convergent beams may be used in circumstances that will be discussed later. Preferably the x-ray source 205 is connected to the computer 106 by a wired or wireless link 208 so that it can be energised remotely. Alternatively the x-ray source 205 includes a local energy source. The x-ray source 205 is located above the transport system 112 so that cants 104 pass beneath before being sawn. An x-ray radiation detector 206 is located beneath the x-ray source 205 and preferably beneath the transport system 112. The detector 206 is arranged to detect x-ray radiation that has been emitted by the x-ray source 205 and radiated through the cant 104. The changing density of the cant wood causes a varying magnitude of x-ray radiation absorption. The resultant strength of the radiation received by the detector 206 is therefore relative to density of the cant material. Information pertaining to the density of wood across the cant can be directly inferred from the energy received by the x-ray detector.

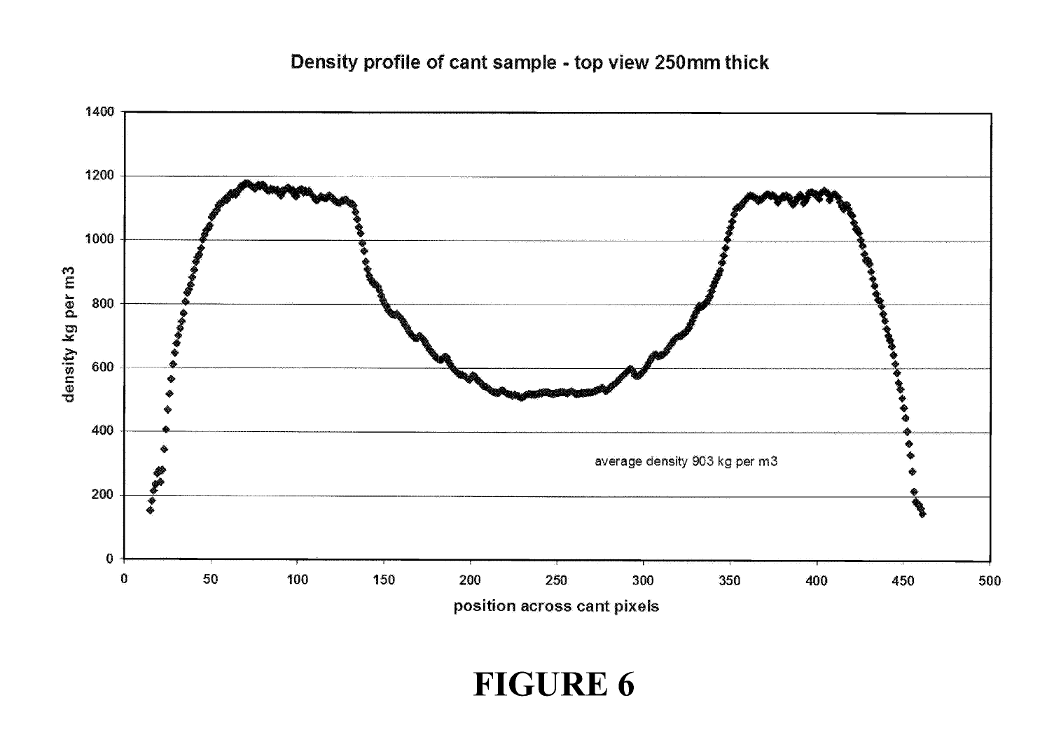

FIG. 6 shows an example of a graph of measured density profile information obtained by scanning an x-ray beam across a cant.

Note that in some embodiments a control cant may need to pass through the x-ray beam such that the energy received by the detector can be calibrated or referenced to a known energy level. In other embodiments an x-ray energy measurement may be taken at the detector, or at least before the beam passes through a cant, such that the energy sensed at the detector can be calibrated or referenced to a known energy level. In other embodiments the energy sensed at the detector is not calibrated or referenced to the x-ray radiation source and only relative measurements are taken. In other embodiments the x-ray attenuation information is compared with density profile information of known types of wood.

In a variation of the above embodiment, the beam of x-ray radiation moves above the cant instead of having the cant move beneath the beam of x-ray radiation. A moveable x-ray radiation source may be facilitated by mounting the x-ray source on a translation stage that moves transverse to the direction cants are transported through the system. Alternatively the x-ray radiation source may be pivoted to scan the beam across the cant. Alternatively an x-ray beam reflector may be located proximate the x-ray source such that the beam direction can be reflected to scan as desired. Movement of the x-ray source, or at least the beam, relative to the cant negates the requirement for cants to move transversely in the transport system. This may be advantageous in sawmills where cants are generally only transported in a longitudinal direction or it is otherwise not practical to install equipment to facilitate transverse movement of a cant.

In some embodiments, the x-ray radiation may be provided by a pencil beam radiation source, or by a radiation source having a diverging beam such that the beam adequately spans the width of a cant when incident. In such instances where a diverging beam is desired, the detector may be a number of discrete devices arranged to receive x-ray radiation at discrete locations, or a continuous detection device arranged to receive a broad beam width.

In preferred embodiments, the x-ray radiation source 205 is a single source of x-ray radiation. However, in other embodiments it may be desirable to have multiple sources of x-ray radiation arranged to provide density information at various lateral and/or longitudinal positions of the cant being scanned. In such circumstances where multiple beams are used, the density profile information retrieved may be averaged such that an average position of minimum density along the cant is determined. Other statistical measures may be employed on multiple readings to establish the most desirable position of minimum density and subsequently generate a sawing pattern from.

In such circumstances where a large deviation in the density profile is discovered along the length of a cant, it may be desirable to cut the cant in two at some longitudinal position. A sawing pattern best suited for each section can then be utilised.

Further arrangements of the x-ray radiation source and detectors suitable for providing a cross-sectional scan of a cant for retrieving density information will be apparent to those skilled in the art.

The inventors have determined that the density information determined from the absorption profile of x-ray radiation at a single longitudinal position on a cant generally corresponds to the density along the entire longitudinal length of the cant. A single scan therefore provides adequate information for determining whether the position of minimum density is offset from the geometrical centre.

Preferably a final determination of the sawing pattern is based on two measures, a measure of acoustic speed/velocity and the density profile information provided by the x-ray scan. The determination of the sawing pattern may be made automatically by a processor of the system or manually by an operator. The sawing pattern depends on the true MoE profile which includes information on the position of minimum density.

To illustrate the effectiveness of the invention a trial was conducted to compare a batch of equal quality cants sawn using both the process for determining the true position of minimum density and the traditional process where the position of minimum density is assumed to be at the geometrical centre of the cant. Approximately 1000 logs were divided into two groups according to their acoustic velocity measure being high or low and thus being designated either high or low quality. The cants having high velocity were those with a mean acoustic velocity of 3.39 km/sec. These cants were the subject of the test since they are more suitable for producing structural grade timber.

The logs were sawn and wing boards were diverted from the board flow so they would not dilute any effect of the sawing treatment applied to the cants. Using a determination of x-ray density and acoustic velocity from the in line cant acoustic velocity measure, the average stiffness of the cants was determined.

FIG. 11 shows a graph of the mean cant MoE for the group having high acoustic velocity. Cant batch 210 was sawn using the process of the invention and shows an improved mean cant stiffness compared to cant batch 211 which was sawn using the traditional process.

In its various aspects, the method of determining the stiffness/MoE profile and/or of determining a sawing pattern of the invention can be embodied in a computer-implemented process, a machine (such as an electronic device, or a general purpose computer or other device that provides a platform on which computer programs can be executed), processes performed by these machines, or an article of manufacture. Such articles can include a computer program product or digital information product in which a computer readable storage medium containing computer program instructions or computer readable data stored thereon, and processes and machines that create and use these articles of manufacture.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention as defined by the accompanying claims.

1. A method of breaking down a stem, log, cant or slab to sawn timber comprising the steps of:
determining an acoustic velocity value for the stem, log, cant or slab,
determining density profile information across the width of the stem, log, cant or slab, including locating a position of minimum density in a stem, log, cant or slab,
predicting a stiffness profile across the stem, log, cant or slab from the acoustic velocity and the density profile information across the stem, log, cant or slab, and
utilising the stiffness profile of the stem, log, cant or slab to generate a sawing pattern for cutting the stem, log, cant or slab.

2. A method as claimed in claim 1 wherein the step of predicting the stiffness profile across the stem, log, cant or slab comprises calculating an initial profile of stiffness across the stem, log, cant or slab from an elasticity model of the stem, log, cant or slab, and determining a stiffness profile using the acoustic velocity value for the stem, log, cant or slab, the density profile information and the initial stiffness profile.

3. A method as claimed in claim 1 wherein the step of determining density profile information includes subjecting the stem, log, cant or slab to x-ray radiation.

4. A method as claimed in claim 3 wherein determining density profile information further includes measuring the x-ray radiation energy level after propagating through the stem, log, cant or slab.

5. A method as claimed in claim 3 wherein the x-ray radiation comprises a collimated beam, a diverging beam, a converging beam, or any combination thereof.

6. A method as claimed in claim 3 wherein the x-ray radiation is provided by one or more radiation sources.

7. A method as claimed in claim 3 further comprising calibrating the x-ray radiation to an energy level prior to subjecting the stem, log, cant or slab to the x-ray radiation.

8. A method as claimed in claim 7 wherein calibrating the x-ray radiation comprises passing a control stem, log, cant or slab through the x-ray radiation and adjusting the x-ray radiation energy level to an appropriate energy level for the control.

9. A method as claimed in claim 3 wherein subjecting the stem, log, cant or slab to x-ray radiation comprises moving the stem, log, cant or slab through at least one beam of x-ray radiation.

10. A method as claimed in claim 1 wherein the step of determining an acoustic velocity value of the stem, log, cant or slab comprises applying a force to the stem, log, cant or slab and measuring a frequency of vibration resulting from the applied force.

11. A method as claimed in claim 1 further comprising forming one or more laser marker lines on the stem, log, cant, or slab in accordance with the sawing pattern and cutting the stem, log, cant or slab with a cutting machine in accordance with the marker lines.

12. A method as claimed in claim 1 further comprising the step of cutting the stem, log, cant or slab by locating a centre of the sawing pattern in a predetermined position relative to the determined position of minimum density of the stem, log, cant or slab.

13. A system for breaking down a stem, log, cant or slab to sawn timber comprising:
a measuring system configured to:
determine an acoustic velocity value for the stem, log, cant or slab, and
determine density profile information across the width of the stem, log, cant or slab, including locate a position of minimum density in a stem, log, cant or slab, and at least one processor configured to predict a stiffness profile across the stem, log, cant or slab from the acoustic velocity and the density profile information across the stem, log, cant or slab, for generating a sawing pattern for cutting the stem, log, cant or slab, wherein the sawing pattern is dependent on the position of minimum density of the stem, log, cant or slab.

14. A system as claimed in claim 13 further comprising an output monitor for displaying stiffness profile across the stem, log, cant or slab.

15. A system as claimed in claim 13 wherein the measurement system comprises at least one x-ray radiation source and at least one x-ray radiation detector configured to locate on either side of the stem, log, cant or slab in a density measurement position of the stem, log, cant or slab in use, the at least one source configured to apply x-ray radiation energy through the stem, log, cant or slab and the at least one detector configured to receive and measure an energy level of x-ray radiation propagating through the stem, log, cant or slab, and the measurement system further comprising at least one processor configured to determine the density profile information from one or more energy levels measured by the at least one detector across the stem, log, cant or slab.

16. A system as claimed in claim 15 wherein the at least one source is located above the stem, log, cant, or slab in the density measurement position, and the at least one detector is located underneath the stem, log, cant or slab in the density measurement position.

17. A system as claimed in claim 13 wherein the measurement system comprises a compressed air driven hammer located adjacent the stem, log, cant or slab in an acoustic velocity measurement position of the stem, log, cant or slab in use and configured to strike the stem, log, cant or slab to stimulate vibration in said stem, log, cant or slab, and an accelerometer configured to locate against an end of the stem, log, cant or slab in the acoustic velocity measurement position in use, and output data relating to a frequency of the vibration, the measurement system further comprising at least one processor configured to determine the acoustic velocity value from the frequency data of the accelerometer.

18. A system as claimed in claim 13 further comprising a cutting system including:
a laser source configured to generate at least one laser marker cutting line on the stem, log, cant or slab corresponding to the sawing pattern, and
a sawing machine configured to cut the stem, log, cant or slab in accordance with the at least one laser marker cutting line.

19. A system as claimed in claim 18 further comprising a transport system configured to convey the stem, log, cant or slab in use first to a measurement stage associated with the measurement system and then to a cutting stage associated with the cutting system.

20. A method of breaking down a stem, log, cant or slab which includes:
determining an acoustic velocity value for the stem, log, cant or slab,
determining density profile information using x-ray radiation across the width of the stem, log, cant or slab, including locating a position of minimum density in a stem, log, cant or slab,
predicting a stiffness profile across the stem, log, cant or slab from the acoustic velocity and the density profile information across the stem, log, cant or slab, and utilising the stiffness profile in cutting the stem, log, cant or slab including locating a sawing pattern for the stem, log, cant or slab by locating a centre of the sawing pattern in a predetermined position relative to the determined position of minimum density of the stem, log, cant or slab.
